(19) United States
(12) Patent Application Publication
(10) Pub. No.: US 2016/0076522 A1
(43) Pub. Date: Mar. 17, 2016

(54) WIND TURBINE ARCHITECTURE

(71) Applicant: YOUWINENERGY GMBH, Oldenburg (DE)

(72) Inventor: Rolf ROHDEN, Aurich (DE)

(73) Assignee: YOUWINENERGY GMBH, Oldenburg (DE)

(21) Appl. No.: 14/786,788

(22) PCT Filed: Apr. 17, 2014
(86) PCT No.: PCT/EP2014/057896

§ 371 Date: Oct. 23, 2015

(30) Foreign Application Priority Data
Apr. 23, 2013 (EP) 13164938.6

(51) Int. Cl. F03D 11/00; F03D 1/06; F03D 7/02; F03D 9/00

(52) U.S. Cl. CPC F03D 11/0058; F03D 9/002; F03D 11/0075; F03D 1/0666; F03D 7/0204

(57) ABSTRACT

A wind turbine arrangement is disclosed which comprises a rotor hub (3), a generator (4, 6), a nacelle (7) and a yaw shaft (9). The rotor hub (3) is coupled with a plurality of rotor blades. The generator (4, 6) has a rotor (4) and a stator (6), wherein the rotor (4) has mounted thereupon the rotor hub (3). The rotor (4) is rotatably supported on the stator (6). The nacelle (7) supports the stator (6) and the yaw shaft (9) supports the nacelle (7).

The present subject matter relates to wind turbine architecture and in particular to a wind turbine arrangement having a novel mounting structure.

In commonly known wind turbines, the generator is supported on a machine support which is housed within a nacelle. Commonly used generators provide a stator and a rotor, wherein the rotor is rotatably mounted with respect to the stator, wherein a hub of the wind turbine is arranged in order to drive the rotor of the generator. Usually, generators are provided with a shaft or similar elements in order to rotatably support the rotor. The shaft is in driving connection to the hub in order to transmit the torque of the hub to the rotor of the generator.

### SUMMARY

The present subject matter relates to a wind turbine arrangement having an enhanced structure which provides an optimized transmission of forces from elements of the wind turbine to the ground where the tower of the wind turbine is provided.

According to the basic concept of the subject matter, a wind turbine arrangement comprises a rotor hub, the rotor hub being coupled with a plurality of rotor blades, a generator having a rotor and a stator, the rotor having mounted thereupon the rotor hub, and being rotatably supported on the stator, a nacelle supporting the stator, and a yaw shaft for supporting the nacelle.

The concept underlying this arrangement is completely novel and provides various advantageous effects. In particular, according to the basic concept of the present subject matter, the rotor hub is coupled with a plurality of rotor blades. Consequently, the rotor blades transmit a force for rotating the rotor hub which is generated by a wind force. The rotor hub is mounted to the rotor of the generator in order to transmit the torque to the rotor of the generator. In order to provide the rotatable arrangement of the rotor of the generator for providing the function of the generator, the rotor is rotatably supported. According to the basic concept of the present subject matter, the rotor is rotatably supported on the stator. The stator is supported on the nacelle, which is, in turn, supported by the yaw shaft.

The present subject matter relates to the support structure of the wind turbine arrangement and it is the concept of the present subject matter that the rotor is rotatably supported on the stator such that the force exerted on the rotor by the rotor hub is directly transmitted to and supported by the stator. Moreover, the stator is mounted to and supported by the nacelle such that the force exerted on the stator by the rotor is transmitted to and supported by the nacelle. Moreover, the nacelle is supported on the yaw shaft such that the forces exerted on the nacelle are transmitted to the yaw shaft. Accordingly, the force which is generated by the wind force exerted on the rotor hub having the blades is transmitted from the rotor hub to the rotor, the stator, the nacelle and the yaw shaft in this sequence. In addition, the reaction force of the stator generated in operation of the generator is transmitted to the nacelle and the yaw shaft in this sequence.

According to the present subject matter, the arrangement is simplified and the operational safety is enhanced. Moreover, a separate machine support for the generator is not required as the generator, as the stator, is supported by the nacelle itself. Therefore, according to the basic concept of the present subject matter, the nacelle has the function of a supporting element for the generator, in particular, the stator of the generator, in the wind turbine arrangement and forms a housing for providing a space inside.

According to an embodiment of the present subject matter, the rotor hub includes at least one non-pitchable portion for carrying at least one rotor blade. According to this embodiment, the wind force can be transmitted to the rotor hub in order to create a torque in the rotor hub by providing at least one rotor blade on the rotor hub.

According to an embodiment of the present subject matter, the rotor is supported by the stator by at least one bearing. According to this embodiment, the rotor and the stator forming the generator can provide both the generic function of the generator and the functionality of rotatably supporting the rotor hub which is mounted on the rotor of the generator.

According to an embodiment of the present subject matter, the generator is a shaftless type. Due to the above arrangement, a shaft for rotatably supporting the rotor is not required as the rotor is rotatably supported on the stator. Arranging the generator as shaftless type provides a compact arrangement which does not require e.g. a cantilevered support of a shaft in at least two axially spaced positions, and specific bearings for rotatably supporting the shaft by a machine support are not required which is the case in usual wind turbine arrangements.

According to an embodiment of the present subject matter, the rotor is exclusively supported on the stator. This means that the rotor only transmits forces to the stator of the generator and not to other elements. As result of this arrangement, the stator is the only element bearing the forces of the rotor and transmitting these forces to the nacelle as support of the stator.

According to an embodiment of the present subject matter, a substantially closed space is formed by the nacelle and the generator mounted onto the nacelle. In particular, the nacelle supports the stator of the generator and the stator rotatably supports the rotor such that this arrangement provides an inner space defined by the generator and the nacelle. Providing a closed space has the advantage of preventing foreign matter or humidity to enter into the closed space such that this closed space can be used for arranging sensitive elements such as control systems or electrical equipment. In the context of the present subject matter, the nacelle can be formed by a single element or can be assembled from more than one element in order to form a shell having a space inside and the capability of carrying the generator and transmitting the forces introduced by the stator of the generator.

According to an embodiment of the present subject matter, a substantial sealing is provided between a rotating part and a stationary part of the wind turbine arrangement. The rotating part at least includes the rotor hub and the rotor of the generator and the stationary part includes the nacelle and the stator of the generator. According to this embodiment, it is further prevented that foreign matter or humidity enters the closed space of the wind turbine arrangement which is provided by the nacelle and the generator. The sealing can be provided by any type as long as a substantial sealing is provided between a rotating part and a stationary part of the wind turbine arrangement.

According to an embodiment of the present subject matter, said substantial sealing is implemented at least in part by or in cooperation of engaging portions of said rotating part and said stationary part. According to this embodiment, engaging portions of said rotating part and said stationary part are employed in order to implement a sealing.

According to an embodiment of the present subject matter, the nacelle is at least in part made of a metal material, preferably cast steel. According to this embodiment, the nacelle can be designed with a high degree of freedom in order to provide the support for the stator of the generator and the capability to transmit the force from the stator to the yaw shaft. Moreover, metal material or preferably cast steel can transmit high forces and can be produced with a very high accuracy in order to provide a nacelle which is capable of providing a support for the stator and a sealing which is implemented based on engaging portions of said rotating part and said stationary part.

According to an embodiment of the present subject matter, one or more electrical systems or control components of the wind turbine are housed in the space provided by the nacelle. As stated above, the closed space provides the advantage of preventing foreign matter or humidity from entering into the closed space such that sensitive elements such as electrical systems or control components can be suitably accommodated in this closed space.

According to an embodiment of the present subject matter, said electrical systems and control components include at least one of a rectifier and a heat exchanger. Optional, an inverter can be accommodated in said closed space, preferably in an optional yaw base. According to this embodiment, elements which are suitably arranged close to the generator can be accommodated in the closed space which provides further advantages with respect to the efficiency and operational safety. Moreover, the closed space provides sufficient space not only for accommodating the above-mentioned elements but enables a convenient maintenance of these and other elements accommodated in the closed space.

According to an embodiment of the present subject matter, the rotor hub is directly mountable onto the nacelle through the stator. The above arrangement results in a simplified structure as the rotor hub can be mounted to the nacelle without the requirement to provide additional support structures for the rotor hub except the stator of the generator. In particular, the mounting procedure of mounting the rotor hub to the wind turbine arrangement is enhanced and simplified as means for transmitting the rotation from the rotor hub to the generator can be part of the rotor hub.

According to an embodiment of the present subject matter, one or more fins are provided on the outer surface of the rotor hub serving as heat sink for extracting heat from inside the rotor hub to the outside. According to the present embodiment, the rotor hub is supported by the rotor of the generator such that heat generated by the operation of the generator is transmitted to the inner space of the rotor hub. The one or more fins provided on the outer surface of the rotor hub enhance the cooling effect and contribute to an increase of operational safety and overall efficiency of the wind turbine.

According to an embodiment of the present subject matter, one or more heat exchangers are provided on the outside of the nacelle for extracting heat from inside the nacelle to the outside. According to this embodiment, heat generated by the operation of the generator and of the further elements dissipating the heat inside the closed space can be cooled by transmitting the heat in the inside of the closed space to the outside of the nacelle which is in turn transferred to the outside atmosphere. Based on this embodiment, the overall efficiency and operational safety of the wind turbine can be enhanced.

According to an embodiment of the present subject matter, the nacelle is a load bearing construction for mounting on a tower of a wind turbine and includes structural elements for supporting the stator of the generator. The nacelle according to the present subject matter is a load bearing construction in addition to a housing. Therefore, the nacelle is capable of transmitting forces by means of the material of the nacelle and serves as support for the stator of the generator in a way that forces introduced from the stator into the nacelle can be further transmitted from the nacelle to the tower of the wind turbine. Accordingly, an additional functionality is added to the nacelle according to the concept of this embodiment.

According to an embodiment of the present subject matter, the nacelle comprises means for supporting the stator which include at least one of a flange, a set of protrusions and a rim or equivalent means. According to this embodiment, the stator of the generator is supported by means for supporting the stator which are part of the nacelle or at least provided on or in the nacelle in order to provide an arrangement which enables the transmission of the force from the stator of the generator to the nacelle. Based on this embodiment, a distinguished machine support is not required as the forces transmitted from the stator are borne by the nacelle.

According to an embodiment of the present subject matter, said means for supporting the stator is formed integrally in the nacelle. Integrally forming said means for supporting the stator provides a simplified arrangement which in turn provides an improved arrangement for transmitting the forces of the stator of the generator to the nacelle. Moreover, a specific arrangement in the nacelle such as a machine support is not required and an adjustment of the position of a specific support for the generator is simplified.

According to an embodiment of the present subject matter, the rotor hub forms a substantially closed space enclosed by the inner surface of the rotor hub and one of the generator. Accordingly, heat produced by the generator can be dissipated to the closed space formed by the rotor hub and one end of the generator and can be transmitted to the outside at the outer surface of the rotor hub. Moreover, this arrangement prevents foreign matter or humidity from entering into the closed space enclosed by the inner surface of the rotor hub and one end of the generator which increases the operational safety of the generator. In this embodiment, it is possible to employ a rotor hub which is formed by a single piece or, as alternative, formed by more than one piece which are mounted to each other to form the rotor hub.

According to an embodiment of the present subject matter, the yaw shaft further includes attaching means for fixedly attaching the nacelle to the yaw shaft. Attaching means for fixedly attaching the nacelle to the yaw shaft provides an arrangement for transmitting the force from the nacelle to the yaw shaft. The yaw shaft in turn transmits the force to a tower on which the yaw shaft is rotatably mountable.

Furthermore, a wind turbine installation is provided which comprises the wind turbine arrangement defined in one or more embodiments discussed above, wherein the wind turbine arrangement is rotatably mounted onto the supporting tower. According to this concept, a wind turbine installation can be provided which has a simplified structure and, at the same time, an improved operational safety which is enabled by providing a force transmitting path from the rotor hub to the rotor of the generator, the stator of the generator, the nacelle, the yaw shaft and the tower in this sequence.

### BRIEF DESCRIPTION OF THE DRAWINGS

FIG. 1 shows the wind turbine arrangement according to an embodiment in a sectional side view;

FIG. 2 shows the wind turbine arrangement according to an embodiment in a front view;

FIG. 3 shows a nacelle according an embodiment in a three-dimensional view;

FIG. 4 shows the nacelle of FIG. 3 in a front view;

FIG. 5 shows the nacelle of FIG. 3 in a side view;

FIG. 6 shows a central tube support adaptor in a three-dimensional view according to an embodiment;

FIG. 7 shows the stator support of FIG. 6 in a front view;

FIG. 8 shows the central tube support adaptor of FIG. 6 in a side view;

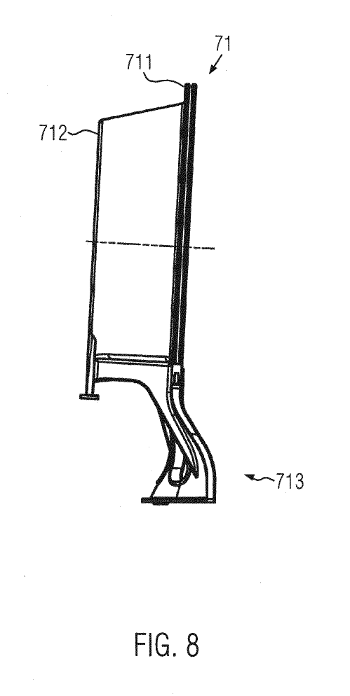

FIG. 9 shows the central tube support adaptor of FIG. 6 in a sectional side view;

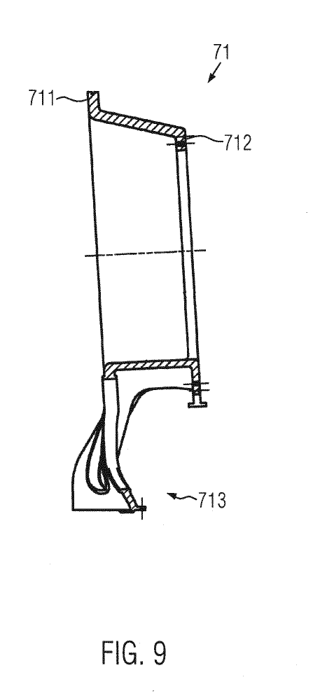

FIG. 10 shows the central tube support adaptor of FIG. 6 in a view from the rear;

FIG. 11 shows a yaw base in a three-dimensional view according to an embodiment;

FIG. 12 shows the yaw base of FIG. 11 in a view from the rear side;

FIG. 13 shows the yaw base of FIG. 11 in a sectional side view;

FIG. 14 shows the yaw base of FIG. 11 in a sectional top view;

FIG. 15 shows the yaw base of FIG. 11 in a top view;

FIG. 16 shows a rotor hub in a three-dimensional view according an embodiment;

FIG. 17 shows the rotor hub of FIG. 16 in a view from the rear side;

FIG. 18 shows the rotor hub of FIG. 16 in a side view;

FIG. 19 shows sections of the rotor housing in a three-dimensional view according to an embodiment;

FIG. 20 shows the rotor housing of FIG. 19 in an axial view;

FIG. 21 shows the embodiment of the wind turbine arrangement of FIG. 1 with exemplary force transmitting paths indicated by bold dash lines.

### DESCRIPTION OF THE EMBODIMENTS

In the following, an embodiment of the present subject matter is explained based on the drawings. It is noted that the drawings show a specific embodiment as explained below and further alternative modifications as specified in the description are at least in part not illustrated.

### EMBODIMENT

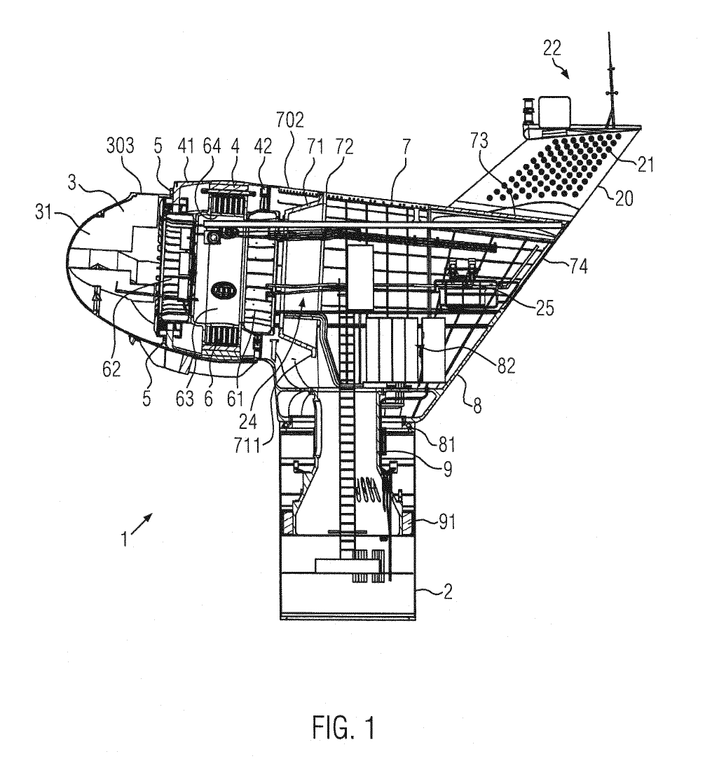

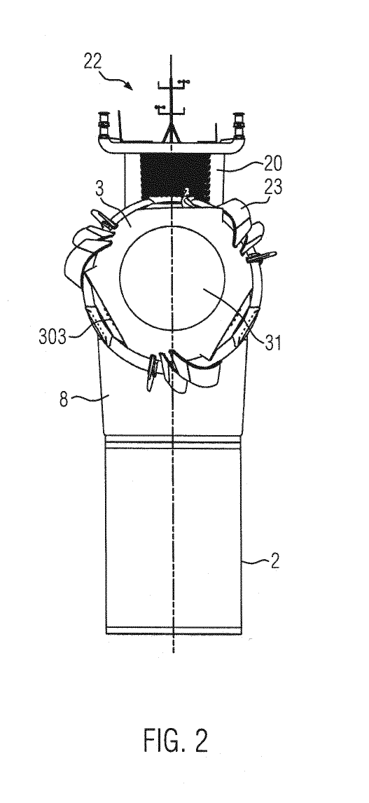

An embodiment of a wind turbine arrangement 1 according to the present subject matter is shown in FIG. 1 in a sectional side view. FIG. 2 shows the wind turbine arrangement 1 according to this embodiment in a front view. As can be seen in FIG. 1, the wind turbine arrangement 1 includes a nacelle 7, which provides a hollow space inside. The nacelle 7 includes a yaw base 8 which is a part of the outer shell of the nacelle 7. As alternative which is not shown, the nacelle and the yaw base can be unified to one body. In front of the nacelle 7, a generator is provided which includes a stator 6 and a rotor 4. In the present embodiment, the rotor 4 is arranged radially outside the stator 6. In the front most section of the wind turbine arrangement 1 shown in FIG. 1, a rotor hub 3 is shown which includes blade supports 303 at the radial outer are of the rotor hub 3 forming non-pitchable portions of the rotor hub 3. The rotor hub 3 is connected to a rotor housing 41, which carries the rotor 4 on the radial inner side thereof.

The wind turbine arrangement 1 according to the present subject matter is characterized by a specific and novel support structure of the rotor hub 3, the rotor 4 and the stator 6 on the nacelle 7. In the following, the elements and the specific supporting structure is explained in more detail.

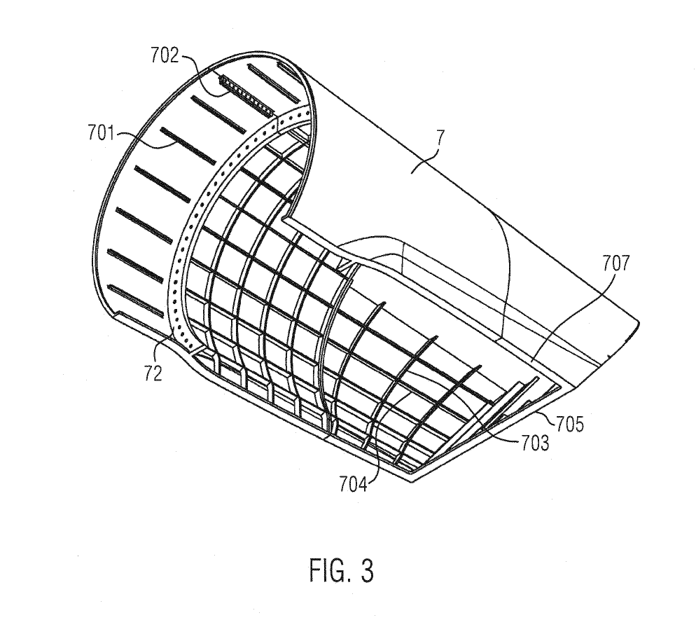

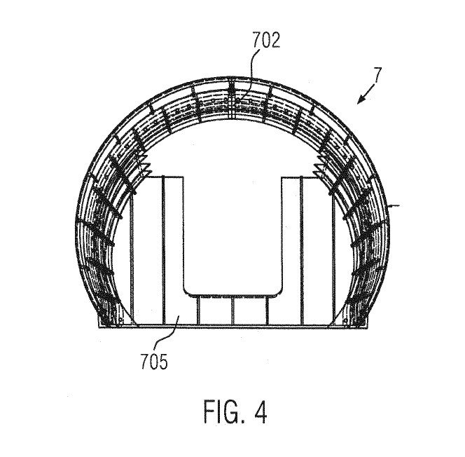

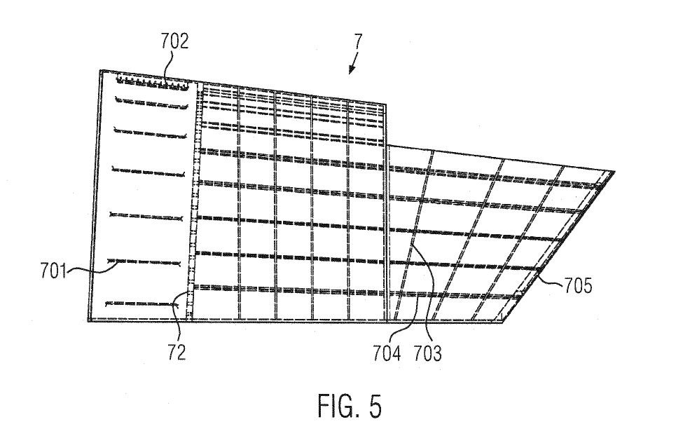

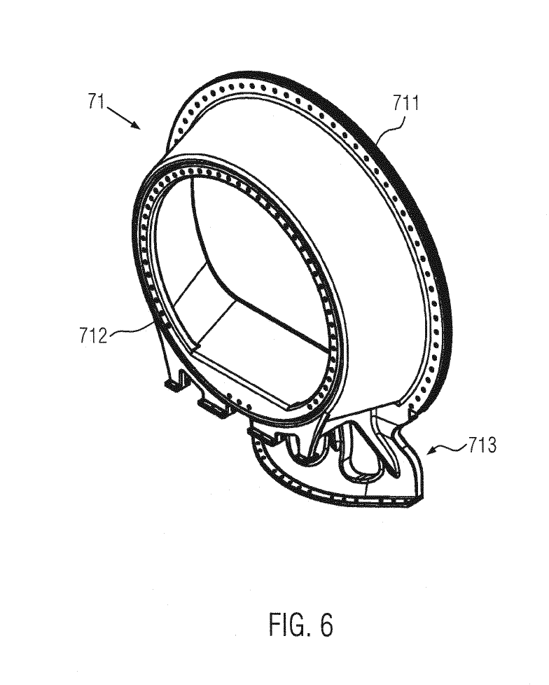

The nacelle 7 is shown in more detail in FIGS. 3-5. As shown in FIG. 3, the nacelle is formed with a shape which is similar to a cylindrical shape having a longitudinal axis. The nacelle 7 shown in FIG. 3 is open at the bottom and has an opening on the top-rear side thereof as shown in FIG. 4. As can be derived from FIG. 3, the nacelle 7 is divided in two parts at a symmetric mating line on top of the nacelle wherein nacelle mounting portions 702 are provided on the inside of each section of the nacelle 7 for mounting the sections at the mating line. The inner surface of the nacelle 7 is provided with radial ribs 703 and longitudinal ribs 704 as can be seen in FIG. 3 and FIG. 5. At the axial end portion of the nacelle 7, a rear wall 705 is provided which is inclined with respect to the longitudinal axis of the nacelle 7. On the inner side of the nacelle, a mounting flange 72 is provided as shown in FIG. 3 which forms a structural element of the nacelle for supporting the stator of the generator. The mounting flange 72 is formed as rib extending from the inner surface of the nacelle 7 and is provided with holes which substantially extend in the longitudinal direction of the nacelle 7. The mounting flange 72 is provided in a front portion of the nacelle 7 with respect to the longitudinal direction, wherein a section of the nacelle 7 extends further towards the front from the mounting flange 72. In this extension, longitudinal ribs 701 are provided as can be derived from FIG. 3. On the bottom side of the nacelle 7, which is open before mounting the wind turbine arrangement 1, a mounting portion 707 is provided in order to mount the yaw base 8 to the nacelle 7 as explained below. The wind turbine arrangement in FIG. 1 shows the nacelle 7 with the yaw base 8 being mounted at the bottom side of the nacelle 7. As can be seen in FIG. 1, the mounting flange 72 is arranged in the nacelle 7 and provides a slight inclination with respect to the horizontal direction when the wind turbine arrangement 1 is mounted and installed. A central tube support adaptor 71 is provided on the mounting flange 72. The central tube support adaptor 71 is shown in more detail in FIG. 6. The ribs in the nacelle 7 form a part of structural elements for supporting the stator of the generator together with the main body of the nacelle 7. The ribs in the nacelle are not strictly required as long as the function of the nacelle 7 for supporting and transmitting the forces of the elements of the wind turbine arrangement is enabled. It is noted in the present application that the nacelle 7 is defined as forming a closed space together with the stator 6 of the generator.

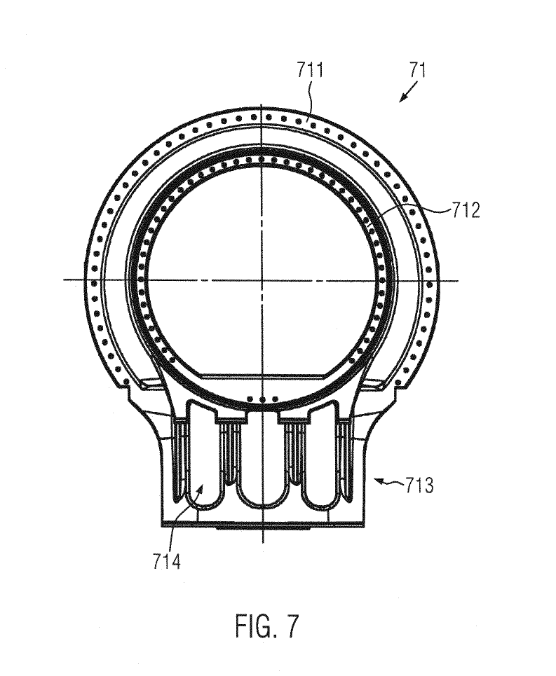

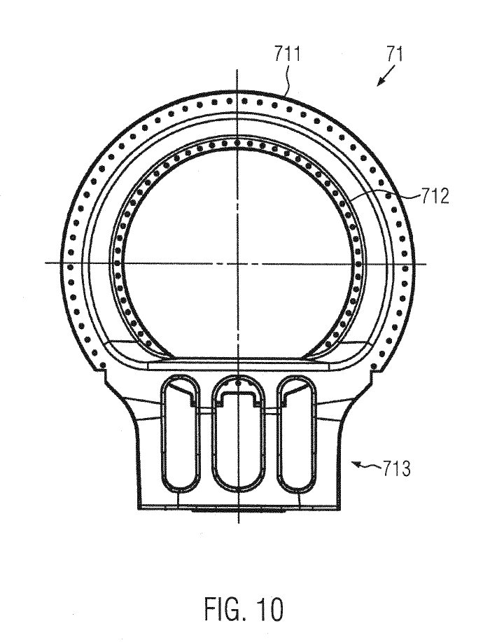

As can be seen in FIG. 6, the central tube support adaptor 71 includes a large adaptor flange 711 and a small adaptor flange 712. FIG. 6 discloses that the large adaptor flange 711 is connected to the small adaptor flange 712 such that the adaptor flanges are spaced from each other. On the lower side of the central tube support adaptor 71 in the Figure, an installation extension 713 is provided. As can be seen in FIGS. 7 and 10, the installation extension 713 includes openings 714 which are adapted to lead conduits and wires from the front side of the wind turbine arrangement to the back side, i.e. the closed space in the nacelle 7. The large adaptor flange 711 and the small adaptor flange 712 are provided with holes for mounting the central tube support adaptor 71.

The central tube support adaptor 71 is mounted to the mounting flange 72 of the nacelle 7, as can be derived from FIG. 1. The small adaptor flange 712 of the central tube support adaptor 71 carries a central tube which includes an inner central tube section 61, an outer central tube section and 62 and an intermediate central tube section 63 as can be derived from FIG. 1. The central tube 600carries the stator 6 via a stator housing 64 on the intermediate central tube section 63 as shown in FIG. 1. On the front side of the intermediate central tube section 63 which supports the stator support 64, the outer central tube section 62 is provided which forms a bearing support. On the outer circumference of the outer central tube section 62, a bearing arrangement 5 is provided. The bearing arrangement 5 will be explained below.

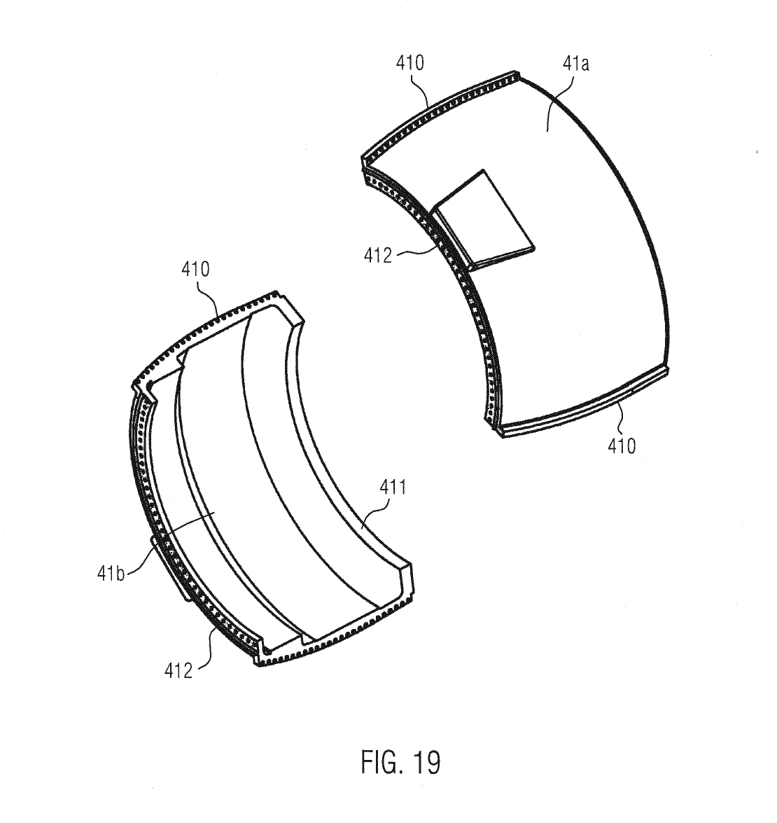

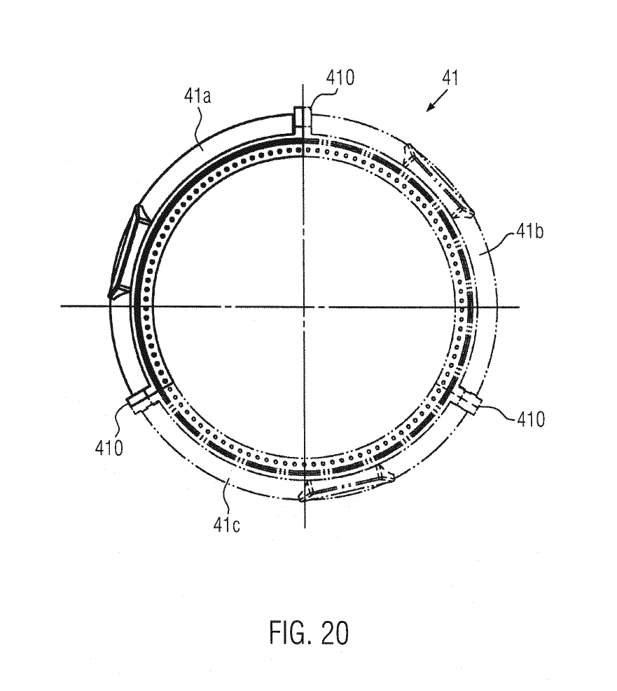

As mentioned above, the wind turbine arrangement 1 shown in FIG. 1 includes a rotor housing 41 which is shown in FIGS. 19 and 20. In the present embodiment, the rotor housing 41 includes multiple rotor housing sections 41a, 41b, 41c, in the present embodiment the number of sections is three. Each section 41a, 41b, 41c can be mounted at respective mating surfaces 410 in order to obtain a circular rotor housing 41 as shown in FIG. 20. The rotor housing 41 includes a radial bearing rib 411 and a radial sealing rib 412.

As can be seen in FIG. 1, the rotor housing 41 has its bearing rib 411 on the front side of the wind turbine arrangement 1 and the sealing rib 412 in the rear side thereof. Moreover, the rotor 4 of the generator is mounted on the inner side of the rotor housing 41 opposing the stator 6 with a small gap between the rotor 4 and the stator 6. The rotor housing is arranged with its bearing rib 411 on a bearing arrangement 5 as shown in FIG. 1. The inner ring or element of the bearing arrangement 5 is mounted on the outer central tube section 62, in particular, on the radial outer portion thereof. The outer ring of the bearing arrangement 5 is formed by or arranged on the bearing rib 411 of the rotor housing 41. Consequently, the rotor housing is rotatably mounted on the outer central tube section 62 such that the rotation of the rotor housing 41 provides a rotation of the rotor 4 with respect to the stator 6.

On the rear side of the rotor housing 41, a sealing arrangement 42 is provided. In particular, the sealing rib 412 of the rotor housing 41 is provided with a sealing with respect to the front and of the nacelle 7. The sealing arrangement 42 comprises a labyrinth element which is provided on the radial outer side of the inner central tube section 61 and which comprises stationary elements which sealingly engage with rotating elements which are mounted on the sealing rib 412 of the rotor housing 41. The stationary elements and the rotating elements of the labyrinth sealing are formed as lamellae which are alternatingly arranged. As a consequence, a sealing of the space on the side of the rotor housing 41 with respect to the space in the nacelle 7 is provided which at the same time enables the rotation of the rotor housing 41 with respect to the nacelle 7. In the present embodiment, the outer surface of the rotor housing is substantially flush with the outer surface of the nacelle 7.

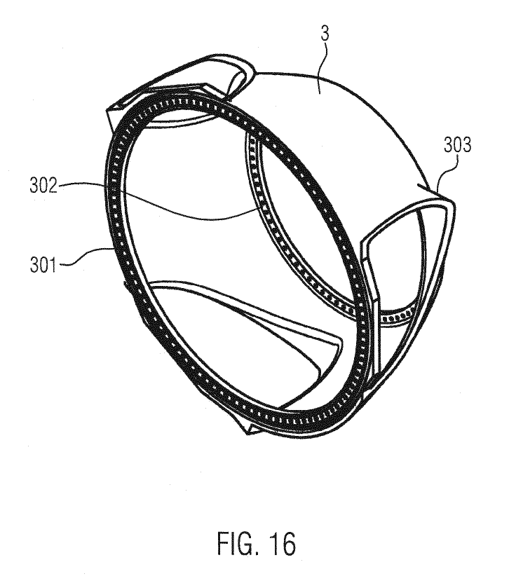

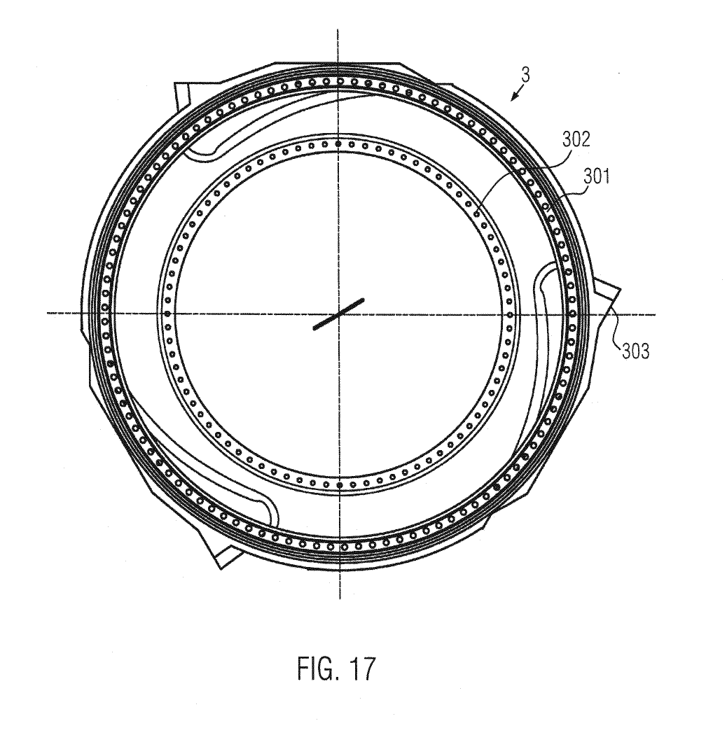

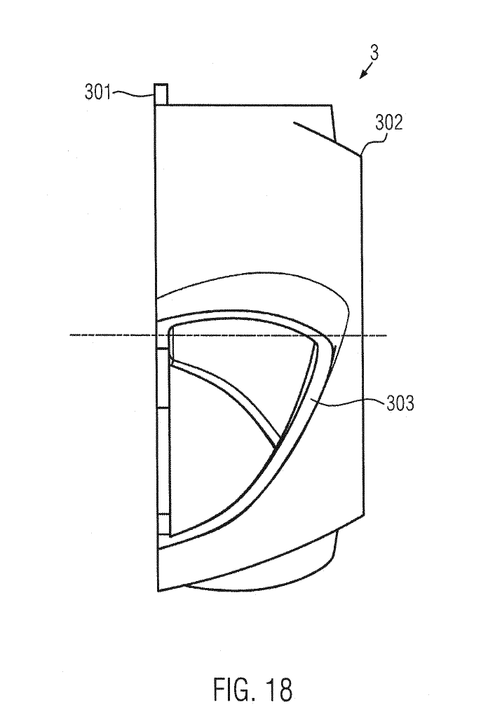

On the axial front side of the rotor housing 41, the rotor hub 3 is mounted. In particular, the rotor hub 3 shown in FIGS. 16-18 includes a large rotor hub flange 301 and a small rotor hub flange 302. The large rotor hub flange 301 is provided on the axial backside or rear side of the rotor hub 3 when mounted. The large rotor hub flange 301 is mounted to the rotor housing 4 as can be derived from FIG. 1. Consequently, a rotation of the rotor 3 leads to the rotation of the rotor housing 41 and the rotor 4. On the radial front side of the rotor hub 3, a rotor face 31 is provided and mounted to the small rotor hub flange 302. A hub rotor is formed by mounting the rotor face 31 to the rotor hub 3. As indicated above, the rotor hub 3 includes blade supports 303 as can be derived from FIGS. 16-18. In the present embodiment, three blade supports 303 are provided in the rotor 3 in order to carry three blades. The rotor hub 3 shown in FIGS. 16-18 is preferably made of a single piece except for the rotor face 31 as stated above. However, it is possible to form the hub rotor as single piece which does not require mounting the rotor face 31 to the rotor hub 3 in order to form the hub rotor.

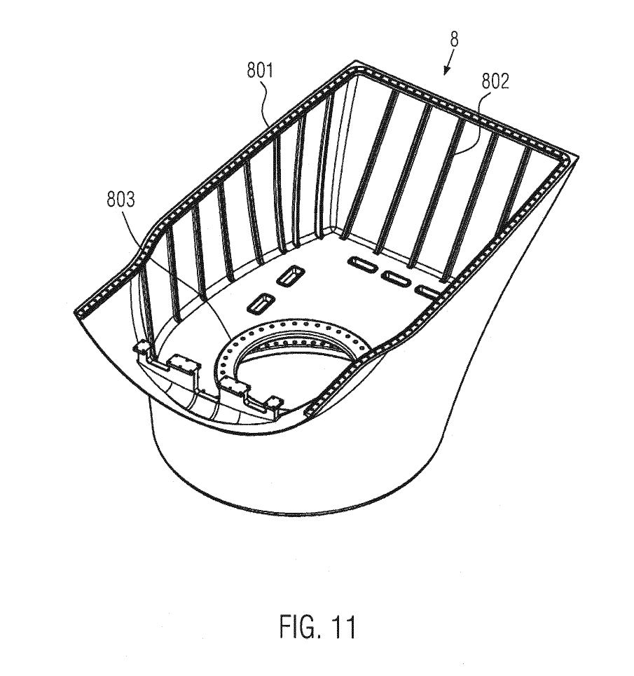

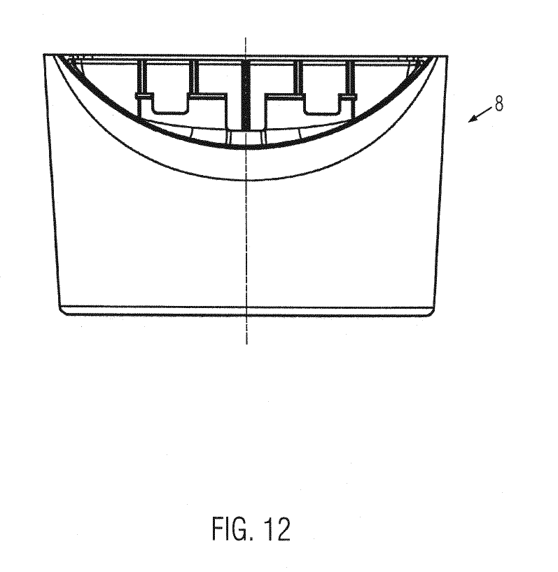

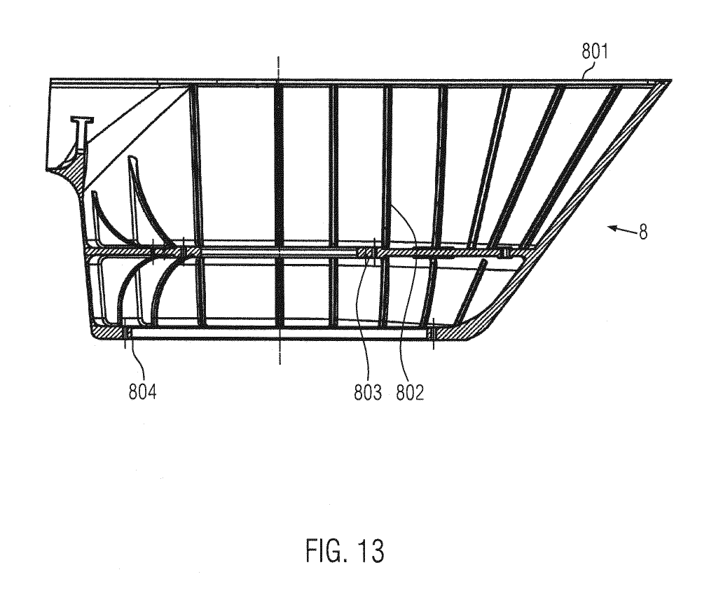

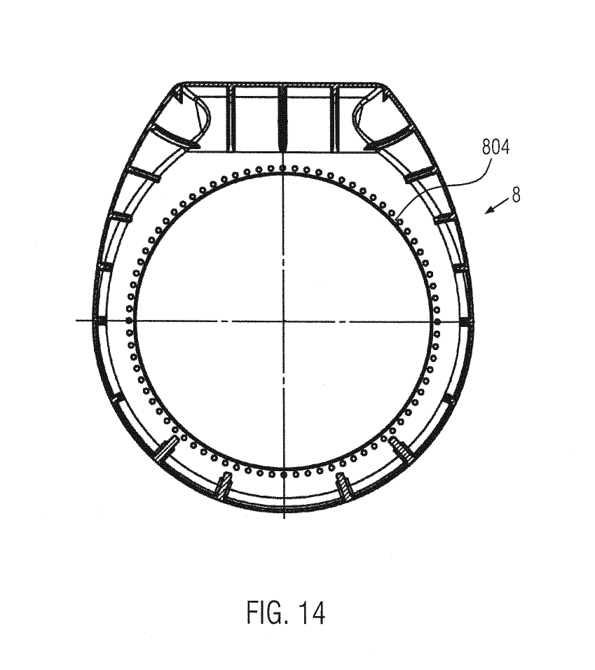

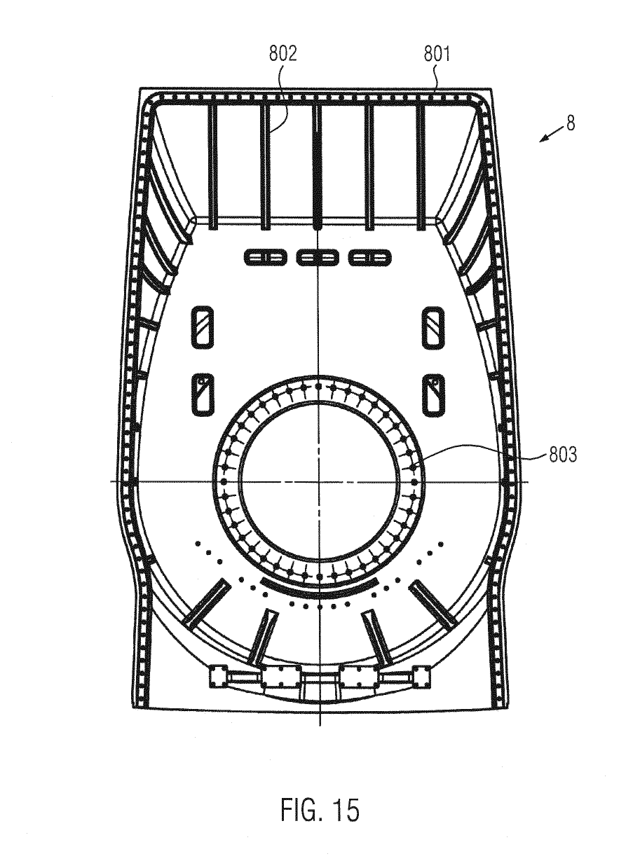

The nacelle shown in FIGS. 3-5 is mounted to the yaw base 8 as discussed above. The yaw base 8 is shown in more detail in FIGS. 11-15. As can be derived from FIG. 11, the yaw base 8 has a shape which is adapted to be mounted to the bottom side of the nacelle 7 which is shown in FIG. 3. In particular, a nacelle mounting portion 801 shown in FIG. 11 is adapted to a yaw base mounting portion 707 shown in FIG. 3, for example. Moreover, a plurality of ribs 802 for reinforcing the structure of the yaw base 8 is provided on the inner side of the yaw base 8. As can be seen in FIGS. 14 and 15, an upper yaw base flange 803 and a lower yaw base flange 804 are provided in the structure of the yaw base 8. The upper and lower yaw base mounting flanges 803, 804 are provided for mounting the yaw base 8 to a yaw shaft 9 as explained below.

As can be seen in FIG. 1, the yaw shaft 9 is formed as a tubular element, which is supported on the tower 2. The tower 2 is mounted on the ground or any other structure in order to provide support for the wind turbine arrangement 1. The yaw shaft 9 is mounted on top of the tower 2 by means of a bearing arrangement 81 for allowing a rotation of the yaw shaft 9 above the longitudinal axis of the tower 2. On top of the rotatably mounted yaw shaft 9, the above explained yaw base 8 is mounted by the upper yaw base mounting flange 803 and the lower yaw base mounting flange 804. As explained above, the nacelle 7 is mounted to the yaw base 8. On top of the nacelle 7, a top section 20 is arranged. The top section closes the top opening of the nacelle 7 shown in FIG. 4, for example. For this purpose, below the top section 20, a nacelle lid 73 forming the bottom side of the top section 20 for closing the nacelle 7 is provided as can be seen in FIG. 1. The nacelle lid 73 preferably has load bearing capabilities for transmitting forces introduced into the nacelle 7. Furthermore, the backside opening of the nacelle 7 is closed by a backside lid 74 shown in FIG. 1 which preferably is only provided for closing the opening in the backside of the nacelle. The top section 20 includes a heat exchanger 21 for transferring heat from the inside of the nacelle 7 to the outside, as explained below. Moreover, outer equipment 22 is arranged on top of the top section 20 as can be derived from FIG. 1.

As explained above, the nacelle 7 provides a closed space together with the generator mounted on the front side of the nacelle. In particular, the sealing arrangement 42 provides a sealing between the rotating element of the wind turbine arrangement 1 and the stationary element thereof. The rotating element of the wind turbine arrangement 1 is represented by the rotor hub 3, the blades to be mounted to the blade supports 303, the rotor housing 41 and the rotor 4. The rotating part of the wind turbine arrangement 1 is supported on the outer central tube section 62, which is the front part of the central tube which is mounted to the central tube adaptor 71. The central tube support adaptor 71 is in turn mounted to the mounting flange 72 provided in the nacelle 7. Consequently, forces transmitted from the rotating portion of the wind turbine arrangement 1 are introduced to the stationary portion of the wind turbine arrangement 1 which includes the stator 6 of the generator which is at least mounted onto the nacelle 7. Therefore, the rotor 4 of the generator is supported only by the stator 6 of the generator.

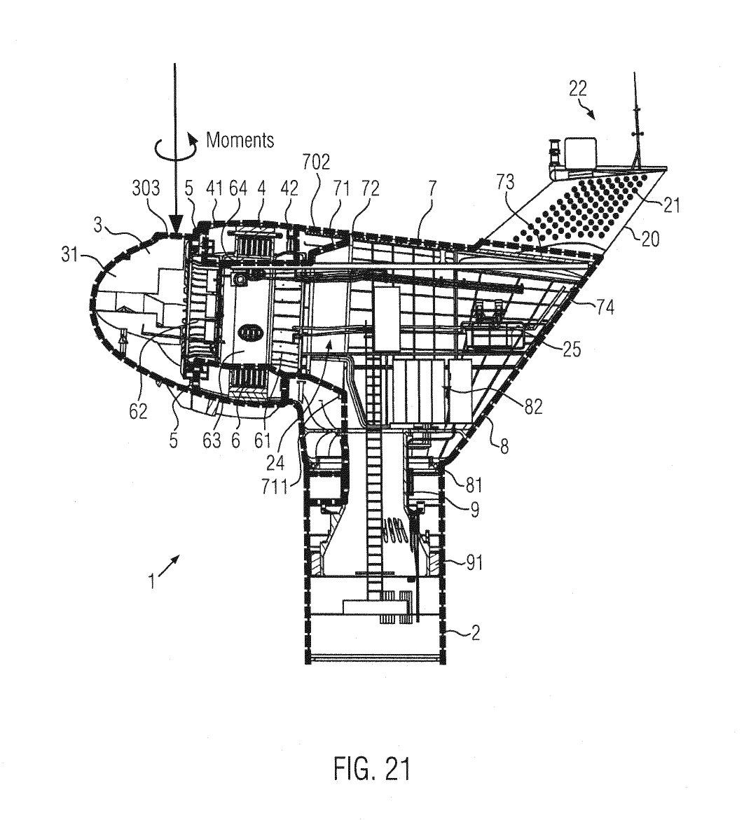

The force introduced into the nacelle from the rotating portion of the wind turbine arrangement is transferred through the construction of the nacelle 7 and the yaw base 8 to the yaw shaft 9 which, in turn, transmits the forces via a yaw bearing arrangement 81 to the tower 2. A possible transmission path of the forces transmitted by the above mentioned elements is shown in FIG. 21. This Fig. is based on the illustration of FIG. 1 and indicates the transmission paths by bold dash lines.

Moreover, a yaw drive mechanism 91 is provided between the tower 2 and the yaw shaft 9 in order to rotate the yaw shaft 9 and the nacelle 7 in a controlled manner. It follows, that according to the basic concept, no machine support for supporting the generator is required as in the prior art. Rather, the nacelle 7 provides the support based on the special construction of the nacelle itself and the generator arrangement which is a shaftless type due to the fact that the rotor 4 is rotatably mounted exclusively to the stator 6 as can be derived from the arrangement of FIG. 1. In particular, the exclusive mounting of the rotor 4 to the stator 6 shall include the concept of arranging elements between the rotor 4 and the stator 6, such as the outer central tube section 62 or the intermediate central tube section 63 which are connected to the inner central tube section 61, as long as the force or load from the rotor 4 is transmitted to the stator 6 and its elements.

It follows from the above, that the closed space within the nacelle 7 does not include the generator which is to be positioned on a machine support. In addition to the structural advantage, which does not require a separate machine support within the nacelle 7, the heat dissipation properties of the entire system are improved. That is, heat generated by the operation of the generator is transmitted to the rotor hub 3 which dissipates the heat to the outside which is exposed to high wind speeds in high load operational state. In order to increase this heat dissipation property, at least one fin, in the embodiment shown in FIG. 2, a plurality of fins 23 is arranged on the outer surface of the rotor hub 3 which enhance the heat transfer rate from the inside of the rotor hub 3 to the outside.

In addition, an active cooling arrangement can be provided which comprises a cooling circuit indicated at the reference sign 24, for example, and which further comprises one or more coolant pumps 25 which are interconnected to a heat exchanger 21 provided in the top section 20. The coolant is circulated through those portions of the generator, in particular, of the stator 6 which need to be cooled. The heat transferred to the coolant is transported to the heat exchanger 21 in which the coolant is cooled by the wind and recirculated to the coolant circuit 24.

Inside the closed space of the nacelle 7, electrical components 82, such as rectifiers, control systems, transformers and the like, can be arranged. It is a specific advantage to provide this closed space within the nacelle 7 as it is not required to select the components in view of the requirement of the hazardous atmosphere and rather standardized elements can be used due to the fact that foreign matter or humidity is prevented from entering into the closed space of the nacelle 7.

It is a further advantage that the closed space provides the option of entering into this space e.g. through the yaw shaft 9 as the space within the nacelle 7 is enlarged compared to the prior art wind turbine arrangement and does not include the generator as the generator is provided outside the closed space of the nacelle 7, in particular, in front of the nacelle 7.

### MODIFICATIONS

According to the above embodiment, the rotor of the generator is shown as an outside rotor type having the rotor 4 radially outside of the stator 6. However, it is possible to apply the above concept to an inside rotor type in which the rotor is radially inside the stator. The same advantages will be obtained as long as the rotor is supported on the stator and is, as such, of a shaftless type.

In the above embodiment, the bearing arrangement 5 is shown as a single arrangement for rotatably supporting the rotor on the stator. However, it is possible to provide two or even more bearings on the stator or a support element which is mounted to the stator in order to enhance the stability of the rotatable connection of the rotor on the stator. The bearing arrangement can include ball bearings, roller bearings or other types which are suitable for this purpose.

It is possible to use a generator which employs an active excitation as well as a permanent magnet type. The type of the generator is not essential for the present invention as long as the rotor is rotatably supported on the stator.

The nacelle 7 and/or the yaw base 8 and/or other elements forming the wind turbine arrangement, such as the rotor hub 3 and the yaw shaft 9, can be formed by a metal based material, such as steel cast. However, the invention is not limited to the specific material as long as the nacelle forms the closed space and the nacelle is capable of supporting the stator of the generator directly or by means of an intermediate element such that the forces for supporting the stator are transferred through the nacelle towards the tower through the remaining elements of the wind turbine arrangement.

The blades of the wind turbine arrangement are not shown in the above embodiment. It is possible to employ one or more blades which can be formed as pitchable or non-pitchable blades. Moreover, it is possible to arrange extensions on the rotor hub 3 which are non-pitchable and carry pitchable sections of the blades such that only a part of the blade is pitchable. The hub rotor can be provided with non-pitchable extensions which provide an aerodynamic effect and which include means for supporting pitchable blade sections which extend from the radial outer ends of the non pitchable blade sections. The pitchable blade sections can be rotatably mounted by a bearing support which is provided at least in part inside the non-pitchable blade sections. A drive mechanism for rotating the pitchable blade sections for controlling the pitch position thereof can be arranged at least in part inside the non-pitchable blade sections. However, the invention is not limited to the type of blades as long as the basic concept is achieved.

In the above embodiment, a labyrinth sealing has been explained for sealing between the rotatable portion of the wind turbine arrangement and the stationary portion thereof. However, the type of sealing arrangement is not essential for the present invention and it is possible to use a lip sealing or other types of sealing as long as the functionality of substantially sealing between the closed space of the nacelle 7 and the space inside the rotating portion of the wind turbine installation is achieved.

The nacelle 7 is shown as an arrangement made of two sections separated in the longitudinal direction as shown e.g. in FIG. 3. However, it is possible to design the nacelle 7 by more than two sections or to form the nacelle 7 as a single part. The same applies to the yaw base and the rotor hub which are shown as single parts but which can, optionally, be formed by two or more separate parts.

In the above embodiment, the closed space is formed by the nacelle 7 as main element and the stator 6 of the generator when mounted to the nacelle 7 in cooperation with the sealing arrangement 42, wherein openings in the main body of the nacelle 7 shown in FIG. 3 are closed by further elements including the yaw base 8, the nacelle lid 73 and optionally further elements. The arrangement of the nacelle 7 and further elements is not restricted to the above embodiment as long as the closed space is formed as discussed above.

### LIST OF REFERENCE SIGNS

1 WIND TURBINE
2 TOWER
3 ROTOR HUB
20 TOP SECTION
21 HEAT EXCHANGER
23 FIN
24 COOLANT CIRCUIT
25 COOLANT PUMP
31 ROTOR FACE
301 SMALL ROTOR HUB FLANGE
302 LARGE ROTOR HUB FLANGE
303 BLADE SUPPORT
4 ROTOR
41 ROTOR HOUSING
41a ROTOR HOUSING SECTION
41b ROTOR HOUSING SECTION
41c ROTOR HOUSING SECTION
410 MATING SURFACE
411 BEARING RIB
412 SEALING RIB
42 SEALING ARRANGMENT
5 BEARING ARRANGEMENT
6 STATOR
61 INNER CENTRAL TUBE SECTOR
62 OUTER CENTRAL TUBE SECTOR
63 INTERMEDIATE CENTRAL TUBE SECTOR
64 STATOR SUPPORT₇ NACELLE
701 LONGITUDINAL RIB
702 NACELLE MOUNTING PORTION
703 RADIAL RIB
704 LONGITUDINAL RIB
705 REAR WALL
707 YAW BASE MOUNTING PORTION
71 CENTRAL TUBE SUPPORT ADAPTOR
711 LARGE ADAPTOR FLANGE
712 SMALL ADAPTOR FLANGE
713 INSTALLATION EXTENSION
714 OPENING
72 MOUNTING FLANGE
73 NACELLE LID
74 BACKSIDE LID
8 YAW BASE
81 YAW BEARING ARRANGEMENT
82 ELECTRICAL COMPONENTS
801 NACELLE MOUNTING PORTION
802 RIB
803 UPPER YAW BASE FLANGE
804 LOWER YAW BASE FLANGE
9 YAW SHAFT
91 YAW DRIVE MECHANISM

1. Wind turbine arrangement (1) comprising:
a rotor hub (3), the rotor hub (3) being coupled with a plurality of rotor blades;
a generator having a rotor (4) and a stator (6), the rotor (4) having mounted thereupon the rotor hub (3), and being rotatably supported on the stator (6);
a nacelle (7) supporting the stator (6); and
a yaw shaft (9) for supporting the nacelle (7).

2. Wind turbine arrangement (1) according to claim 1, wherein the rotor hub (3) includes at least one non-pitchable portion (303) for carrying a rotor blade.

3. Wind turbine arrangement (1) according to claim 1, wherein the rotor (4) is supported on the stator (6) by at least one bearing (5).

4. Wind turbine arrangement (1) according to claim 1, wherein the generator is a shaftless type.

5. Wind turbine arrangement (1) according to claim 1, wherein the rotor (4) is exclusively supported on the stator (6).

6. Wind turbine arrangement (1) according to claim 1, wherein a substantially closed space is formed by the nacelle (7) and the generator (4, 6) mounted onto the nacelle (7).

7. Wind turbine arrangement (1) according claim 1, wherein a substantial sealing (42) is provided between a rotating part and a stationary part of the wind turbine arrangement (1), wherein the rotating part includes the rotor hub (3) and the rotor (4), and the stationary part includes the nacelle (7) and the stator (6).

8. Wind turbine arrangement (1) according to claim 7, wherein said substantial sealing (42) is implemented at least in part by or in cooperation of engaging portions of said rotating part and said stationary part.

9. Wind turbine arrangement (1) according to claim 1, wherein the nacelle (7) is at least in part made of a metal material, preferably cast steel.

10. Wind turbine arrangement (1) according to claim 6, wherein one or more electrical systems or control components (82) for the wind turbine are housed in the space.

11. Wind turbine arrangement (1) according to claim 10, wherein said electrical systems and control components (82) include at least one of a rectifier, an inverter, and a heat exchanging arrangement.

12. Wind turbine arrangement (1) according to claim 1, wherein the rotor (4) of the generator with the rotor hub (3) is directly mountable onto the nacelle (7) through the stator (6).

13. Wind turbine arrangement (1) according to claim 1, wherein one or more fins (23) are provided on the outer surface of the rotor hub (3) serving as heat sink for extracting heat from inside the rotor hub (3) to the outside.

14. Wind turbine arrangement (1) according to claim 1, wherein one or more heat exchangers (21) are provided on the outside of the nacelle (7) for extracting heat from inside the nacelle (7) to the outside.

15. Wind turbine arrangement (1) according to claim 1, wherein the nacelle (7) is a load bearing construction for mounting on a tower (2) of a wind turbine and includes structural elements (72, 701, 703, 704) for supporting the stator (6) of the generator.

16. Wind turbine arrangement (1) according to claim 1, wherein said nacelle (7) comprises means for supporting the stator (6) which include at least one of a flange, a set of protrusions and a rim or equivalent means.

17. Wind turbine arrangement (1) according to claim 16, wherein said means for supporting the stator is formed integrally in the nacelle (7).

18. Wind turbine arrangement (1) according to claim 1, where in the rotor hub (3) forms a substantially closed space enclosed by the inner surface of the rotor hub (3) and one end of the generator.

19. Wind turbine arrangement (1) according to claim 1, wherein the yaw shaft (9) further includes attaching means for fixedly attaching the nacelle to the yaw shaft (9).

20. A wind turbine installation comprising the wind turbine arrangement (1) according to claim 1, the wind turbine arrangement (1) rotatably mounted onto the supporting tower (2).
